(19) United States
(12) Patent Application Publication
(10) Pub. No.: US 2002/0186354 A1
(43) Pub. Date: Dec. 12, 2002

(54) "Prosy" an innovation for outdoor advertisement

(76) Inventors: Theodore Diaz JR., Houston, TX (US); Edmundo Isas, Baytown, TX (US); Jose A. Oliver, Houston, TX (US)

Correspondence Address: THEODORE DIAZ JR., 9501 EVERGIADE ST., HOUSTON, TX, 77029, US

(21) Appl. No.: 09/905,684

(22) Filed: Jul. 16, 2001

Related U.S. Application Data
(60) Provisional application No. 60/238,439, filed on Aug. 2, 2000.

(51) Int. Cl. G03B 21/00

(52) U.S. Cl. 353/122

(57) ABSTRACT

The Prosy, a fully scaleable and customize video player projection system with an extension of using a computer via local area network and broadband wireless is installed on a wooden utility pole (7) set at forty feet from an existing billboard to project full motion video commercials continuously at night The video player (27), the use of a computer via local area network and broadband wireless as an extension of the projection system and the projector (1) are the primary components of the systems, these components operate by a time selector to activate and deactivate at certain hours To energize the system, a twenty-amp breaker that is located at the existing billboard is considered for power source The components have an incapability of operating outdoors therefore, a humidity and temperature system is installed to protect it from heat, humidity, and cold weather. A nitrogen bottle (1A) is the main supply of air circulation to prevent any moisture inside each enclosure (3) To keep each enclosure (3) cool, electric fans (15) are installed. To better service and record the temperature readings, a temperature controller (32) is installed inside each aluminum junction box (31) to protect it from rain or any flying debris With the provisional application that was filed the system was able to be enhance to give better service.

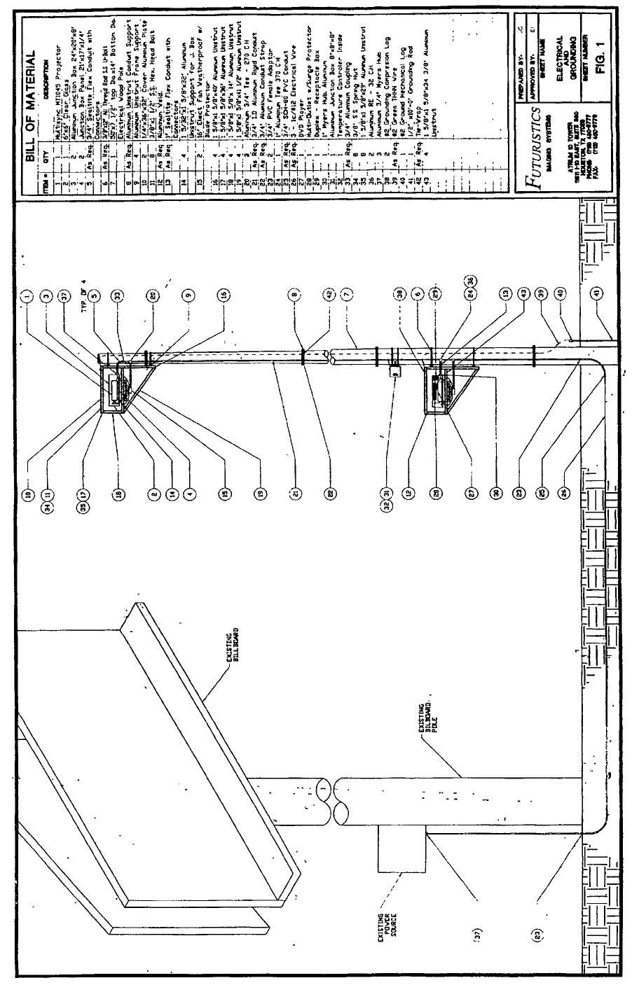

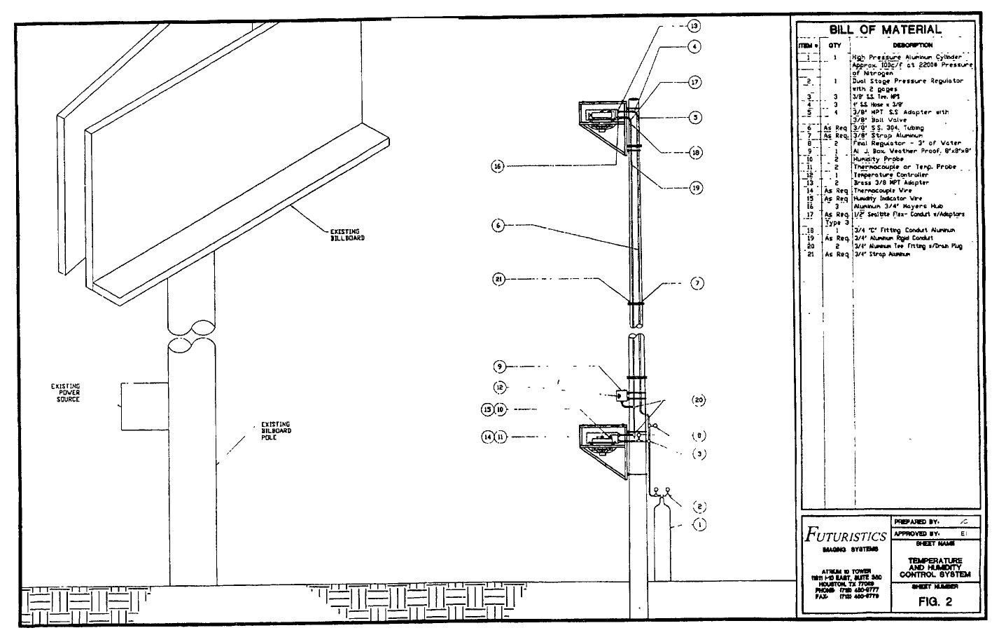

### CROSS-REFERENCE TO RELATED APPLICATIONS

Not Applicable

1. Background—Field of Invention

Futuristic Imaging Systems invented the Prosy to project full motion commercial videos on existing billboards.

2. Background—Description of Prior Art

It's amazing how technology is changing the way companies advertise their business today Any company that doesn't change with the times is certain to fall behind For instance, billboards have been used in advertising for many years and have not changed. Billboards have always had a difficult time getting people's attention The ad has to be pretty exciting to get notice

The hardest part in advertising is to catch the attention of your potential customers But Futuristic Imaging Systems is changing all that They have committed themselves to revolutionize the advertisement industry not only to project television commercials but also to serve the community with alerting news

Imagine the public spotting your message in a moving video Your ad would stand out from all the other billboards The message will be much more effective This is what we meant about technology changing the way companies advertise

### REFERENCE TO MICROFICHE APPENDIX

Not Applicable

### SUMMARY

It is time for a change, existing billboard advertisements have had their days Futuristic Imaging Systems believes that the billboards should not only serve for advertising but also for the following reasons by using the Prosy

| | |
|---|---|
| I. | Emergency Evacuations |
| II. | Chemical Plants Explosions |
| III. | Traffic Delays |
| IV. | Elections |
| V. | Missing Persons Alerts |
| VI. | Weather Warnings |
| VII. | Advertising |

### ADVANTAGES

Before the research of the Prosy was conducted the inventors believed that if the system was going to be invented that it should serve not only for advertisement but, for other media purposes The following Roman Numerals briefly state the advantages for the purpose of the Prosy

| | |
|---|---|
| I. | The Prosy would be able to alert the commuters of traffic delays |
| II. | Promote official elections (mayor, Presidents, council man, etc) |
| III. | Warn residents of weather conditions |
| IV. | Report missing persons |
| V. | Report any emergency evacuations |
| VI. | And better quality of advertisement for customers and consumers |

### BRIEF DESCRIPTION OF DRAWINGS

The following two drawings that are enclosed in the patent application illustrate the “Prosy” components by listing them by number

### ELECTRICAL DRAWINGS

1. Multisync MT1045 Projector

2. 6″×6″ clear glass

3. Aluminum junction box 24″×20″×8″

4. Junction box panel 21″×17″×¼″

5. ¾″ Sealtite Flex Conduit with connectors

6. ⅜″×12″ all treads rod S S U-bolt

7. 50″×7½″ top dia×14″ bottom dia Electrical Wood Pole

8. Aluminum unistrut conduit support

9. Aluminum Unistrut frame support

10. ¼″×36″×32″ Cover Aluminum Plate

11. ⅜″×1½″ Hex Head Bolt

12. Aluminum Weld

13. 1″ Sealtite Flex Conduit with connectors

14. 1⅝″×32″ Aluminum Unistrut for u-bolt support

15. 16″ Elect Fan Weatherproof

16. 1⅝″×1⅝″×40″ Aluminum Unistrut

17. 1⅝″×1⅝″×36″ Aluminum Unistrut

18. 1⅝″×1⅝″×14″ Aluminum Unistrut

19. 1⅝″×1⅝″×41½″ Aluminum unistrut

20. Aluminum ¾″ Tee-270 C H

21. ¾″ Aluminum Rigid Conduit

22. ¾″ Aluminum Conduit strap

23. ¾″ PVC Female Adaptor

24. 1″ Aluminum Tee 370 C H

25. ¾″ SCH-80 PVC Conduit

26. 3-1c/#12 Electrical wire

27. DVD Player

28. Multi-Outlet w/Surge Protector

29. Duplex-Receptacle box

30. 1″ Myers Hub Aluminum

31. Aluminum junction box 8″×8″×8″

32. Temperature Controller Inside

33. ¾″ Aluminum Coupling

34. ⅜″ S S Spring Nut

35. 1⅝″×1⅝″×29″ Aluminum Unistrut

36. Aluminum Reducer-32 C H

37. Aluminum ¾″ Myers Hub

38. #2 Grounding Compression Lug

39. #2 Green THHN Wire

40. #2 Ground Mechanical Lug

41. ½″×10′-0″ Grounding Rod

42. Tie-wraps

### TEMPERATURE AND HUMIDITY CONTROL SYSTEM

1. High Pressure aluminum Cylinder 100 c/f @#2200 Pressure

2. Dual Stage Pressure Regular with 2 gauges

3. ⅜″ S S. Tee NPS

4. 4′ S.S. Hose×⅜″

5. ⅜″ MPT S S. adaptor with ⅜″ ball valve

6. ⅜″ S S 304 Tubing

7. ⅜″ Strap Aluminum

8. Final Regulator-3″ of water

9. Aluminum junction Box Weather Proof 8′×8′×8′

10. Humidity Probe

11. Thermocouple or Temp. Probe

12. Temperature Controller

13. Brass ⅜″ MPT Adapter

14. Thermocouple Wire

15. Humidity Indicator Wire

16. ½″ C G B Hub

17. ½″ Sealtite Flex—Conduit w/Adapters

18. ¾″ C Fitting Conduit Aluminum

19. ¾″ Aluminum Rigid Conduit

20. ¾″ Aluminum Tee Fitting w/Drain Plug

### DESCRIPTION OF THE INVENTION

Futuristic Imaging Systems invented Prosy to project full motion commercial videos on existing billboards Three commercials of fifteen seconds each will be aired continously Due to daylight, projection will not be visible, therefor, it would only be able to function at night A variety of white canvases will be installed on the existing billboards to accommodate the contrast of the video during air time

Two major component, a DVD player, along with an extension of using a computer through a local area network and broadband wireless center will be installed to integrate with the projector. A time selector will be used to activate and deactivate the major components at certain hours. These components will be installed on a wooden utility pole setting at forty feet away from the screen Since the major components are not outside devices, a humidity and temperature system needs to be installed to protect them from heat, humidity, and cold weather.

The following roman numerals listed below will instruct any person that specialize in this scientific field step by step (billboards and land are not part of the prosy)

Existing power source from the existing billboard will be used for power source for the Prosy (projection system)

### Structural

I A wooden utility pole 50′×7′½″ top dia and 14″ bottom dia should be installed approximately at forty feet from the existing billboard. The wooden pole should be buried no less than 8′ feet into the ground for stability Wooden utility poles will vary on sizes, depending on the size of the billboard that will be use

II An aluminum welded box bracket 10″×24″×24″ will be fabricated and installed at 10 feet (from the ground) on the wooden utility pole to accommodate the video players to project video commercials The aluminum welded box bracket will have four pieces with measurements of 1⅝″×1⅝″ unistrut at 12″, eight pieces of 1⅝″×1⅝″ unistrut at 24″, and a 41½″ piece of 1⅝″×1⅝″ unistrut for incline support This bracket should be bolted to the utility pole by using ⅜″×12″ all tread bolts

III An aluminum junction box 24″×20″×8″ will be installed inside the aluminum welded box bracket to protect the video player from heat, humidity, and cold weather, or any flying debris that could harm the device

IV A similar aluminum unistrut box like bracket that consists of four pieces of 1⅝″×1⅝″×14″, four pieces of 1⅝″×1⅝″×40″, eight piece of 1⅝″×1⅝″×36″, four pieces of 1⅝″×1⅝″×41½″ will be installed as a bracket for support to accommodate the projector that will be enclose in an aluminum junction box The aluminum junction box 24′×20′×8″ will protect the projector from heat, cold, humidity, and any flying debris that could damage it

### Electrical System

The projection system will energize from the existing source that the billboard has mounted for its lightning A ¾″ conduit with a 3 conductor #12 wire rod will be installed underground from the existing billboard to a duplex receptacle to supply power to a multi-outlet with surge protector to energize the electric fans, the video player, and the projector installed on the wooden utility pole This power source will be on a 20-amp breaker

### Humidity and Temperature Control System

Considering the factor that the projector and the video player are not outside devices a humidity and temperature controller should be installed. A high-pressure aluminum cylinder 100 C/F @#2200 pressure of nitrogen should be installed at the ground with a 4″ S S hose×⅜′ attached to it A ⅜′ S S Tee NPS will be attached to the hose to provide nitrogen to the video player enclosure to control the moisture inside It will also have a 3″ of water regulator at the ⅜′ S S Tee to regulate the circulation A ⅜′ S S 304 Tubing should also be installed at the ⅜′ S.S. Tee to provide nitrogen to the projector to control the moisture Both devices should have electric fans to control the heat on the enclosures

To record and control temperature and better service the equipment, a humidity and temperature probe should be installed to integrate with the temperature controller The controller should be inside of an 8″×8″×8′ enclosure to protect it from rain It is not necessary to provide any nitrogen to it, since the controller is an outdoor device The humidity and temperature probe wire should be installed in a ¾″ rigid conduit connected to the enclosure for temperature readings

1. What we claim as our invention is the “Prosy” (Projection System), a fully scaleable and customize DVD player projection system along with an extension of using a computer through a local area network and broadband wireless connection to project full motion videos on freeway billboards continuously at night
